(19) United States
(12) Patent Application Publication
(10) Pub. No.: US 2026/0307041 A1
(43) Pub. Date: Oct. 8, 2026

(54) SYNTHESIS OF LAYERED MATERIAL FROM EGGSHELL WASTE

(71) Applicants: YILDIZ TEKNIK UNIVERSITESI, Istanbul (TR); YILDIZ TEKNOLOJI TRANSFER OFISI ANONIM SIRKETI, Istanbul (TR)

(72) Inventors: Muge SARI YILMAZ, Istanbul (TR); Deniz SEZGIN, Istanbul (TR); Tarik EREN, Istanbul (TR)

(73) Assignees: YILDIZ TEKNIK UNIVERSITESI, Istanbul (TR); YILDIZ TEKNOLOJI TRANSFER OFISI ANONIM SIRKETI, Istanbul (TR)

(21) Appl. No.: 19/478,861

(22) PCT Filed: Jan. 2, 2025
(86) PCT No.: PCT/TR2025/050002

§ 371 Date: Oct. 27, 2025

(30) Foreign Application Priority Data
Jan. 5, 2024 (TR) 2024/000088

(51) Int. Cl. B01J 20/04; B01J 20/28; C01F 7/784

(52) U.S. Cl. CPC B01J 20/041; B01J 20/28026; C01F 7/784

(57) ABSTRACT

The invention relates to the synthesis of ternary MgCaAl layered double hydroxides (LDH) from eggshells, functionalization of the synthesized LDHs with different polymers, and the use of these obtained new composites in CO2 capture applications. WO

### CROSS REFERENCE TO THE RELATED APPLICATIONS

This application is the national phase entry of International Application No. PCT/TR2025/050002, filed on Jan. 2, 2025, which is based upon and claims priority to Turkish Patent Application No. 2024/000088, filed on Jan. 5, 2024, the entire contents of which are incorporated herein by reference.

### TECHNICAL FIELD

The present invention relates to the synthesis of ternary MgCaAl layered double hydroxide (LDH) from eggshell, the functionalization of these ternary LDHs with different polymers, and the use of the resulting new composites in CO₂ capture applications.

### BACKGROUND

There are studies in the literature on the solution of the eggshell waste problem and the number thereof is increasing day by day. There are many studies in which eggshells are often used as a source of calcium in the production of hydroxyapatite, especially thanks to the high amount of calcium carbonate (CaCO₃) it contains (93-97%).

On the other hand, the production of layered double hydroxide (LDH) from eggshells has been discussed in recent years, and there are very few studies on this subject.

Li et al. produced the Ca—Al and Ca—Fe LDH structures from eggshells (Li et al., 2012a). In another study, the same group tried Ca-Al LDH, which they synthesized from eggshells, to remove uranium from aqueous solutions (Li et al., 2012b).

Foruzin et al., on the other hand, synthesized NiCaFe-LDH from eggshell and used it in electrochemical water oxidation (Foruzin et al., 2020).

These studies in the literature have mostly focused on the production of LDH from eggshells and its use in different areas.

The study on the production of MgCaAl-LDH structures from eggshell wastes and their use in CO₂ adsorption has not been found in the researches.

### SUMMARY

With the present invention, it is possible to synthesize ternary MgCaAl-LDH from eggshell for the first time in the literature, to obtain new composites by functionalizing the synthesized ternary LDHs with different polymers, and to use the new composites obtained for the first time in CO₂ capture applications.

If the present invention is used in sectors such as iron-steel or cement where carbon storage is mandatory, it is aimed to reduce the rate of carbon dioxide released into the atmosphere.

The advantages of the present invention are listed as follows.

With the use of eggshells, which are classified as hazardous waste, as raw material for the first time in the production of ternary MgCaAl LDH, a new usage area is created for waste eggshells, thus both some of the raw materials have been provided free of charge and by contributing to waste management, the negative effects on the environment and human health have been reduced.

Composite materials can be produced by covalently bonding the obtained ternary MgCaAl LDH surfaces with different polymers, and for the first time in the literature, these composites can be used as solid adsorbents to reduce CO₂ emissions.

Since the amine groups in the structure of the composites to be synthesized show affinity for CO₂ molecules and Ca-based LDHs exhibit high reactivity properties with CO₂, a new generation material with high CO₂ capture performance is produced. Thus, a significant contribution is made to CO₂ capture technologies by developing an alternative and more cost-effective and environmentally friendly product to Ca-based LDHs used in existing carbon capture technologies.

With the present invention, it is envisaged that the evaluation of eggshell waste and the development of new eggshell-based composite materials in the CO₂ capture area will contribute to both the literature and Turkey's efforts to reduce CO₂ emissions within the scope of the Paris Climate Agreement and to the goals of reducing emissions and minimizing the amount of waste to be realized within the scope of the Green Deal Action Plan.

### DETAILED DESCRIPTION OF THE EMBODIMENTS

Ternary layered double hydroxides (LDH) are obtained by adding additional different divalent or trivalent metal ions to binary layered double hydroxides. Binary and ternary LDHs have similar microstructure, while ternary LDHs have superior physicochemical properties due to their complex element components.

While the current interest in CO₂ capture studies is mostly focused on binary LDHs, ternary LDHs can show much higher CO₂ adsorption capacities and have been studied less so far.

Within the scope of the present invention, ternary MgCaAl LDH was synthesized from eggshell, and then these said synthesized ternary MgCaAl LDHs were functionalized separately, preferably with polyethyleneimine (PEI) or polyallylamine (PAA), and composites were obtained to be used as CO₂ adsorbents.

Mg-based binary LDHs, which are frequently studied and well known in the literature, generally exhibit low CO₂ capture capacities (Chang et al., 2011). The improved surface basicity of Ca-based LDHs, which have a molecular structure similar to Mg-based LDHs, compared to Mg-based LDHs is due to the electronegativity difference between Ca and Mg. In this case, since CO₂ is an acidic compound, the basic regions in Ca-based LDH facilitate CO₂ adsorption and thus lead to an increase in CO₂ adsorption capacity. For this reason, in the present invention, a ternary Ca-based layered double hydroxide (LDH) structure is synthesized by using eggshells.

LDHs are generally expressed in divalent and trivalent metal cations and anionic groups. The general formula of the LDH structure synthesized within the present invention is [M₁₋ₓ2+Mₓ³⁺(OH)₂]^{x+}. [A_{x/n}]ⁿ⁻. mH₂O. In the formula, M²⁺ and M³⁺ represent Ca²⁺, Mg²⁺and Al³⁺, respectively, and An-represents an anion with high activity, such as Cl³¹ , ClO₄⁻, NO₃⁻, CO₃²⁻, and SO₄²⁻.

The synthesis of ternary MgCaAl-layered double hydroxides (LDH) from eggshells of the present invention, and the production of composite materials by functionalizing these obtained ternary MgCaAl LDHs with different polymers are detailed with the method steps below.

1. Synthesis of Ternary MgCaAl LDH from Eggshell

The synthesis method of ternary MgCaAl layered double hydroxide (MgCaAl-LDH) from eggshell includes calcination of eggshells, dissolving calcined eggshells, adding magnesium nitrate hexahydrate and aluminum nitrate nonahydrate metal salts to the homogeneous solution formed and then stirring thereof, keeping the precipitate at room temperature for a predetermined period of time, then filtering and washing with water, drying the resulting powder and obtaining ternary MgCaAl layered double hydroxides. The synthesis of ternary MgCaAl LDH from eggshell was carried out with some modifications considering the study of Foruzin et al. (2020). (Foruzin, L. J., Rezvani, Z., Habibi, B., 2020. “New ternary-component layered double hydroxide as a low-cost and efficient electrocatalyst for water oxidation: NiCaFe-LDH from eggshell bio-waste”, Applied Clay Science, 188, 105511.)

Here, for synthesis, the eggshells calcined at 950° C. were first kept in an ultrasonic bath under an inert nitrogen atmosphere in a 6 M nitric acid solution for 1 hour and then completely dissolved at 70° C.

Magnesium nitrate hexahydrate and aluminum nitrate nonahydrate metal salts were added to the obtained homogeneous solution with molar ratios of Ca⁺²/Al⁺³: 0.15 and Mg⁺²/Al⁺³: 1.3 and stirred for another 1 hour.

At the end of the period, the pH of the reaction solution obtained was adjusted with NaOH according to the precipitate formation. The pH value at which dense precipitation was observed was recorded as 12.5. Here, precipitation of the reaction solution by pH adjustment is required to obtain LDH. When NaOH was added to the reaction solution, precipitate formation started to occur slowly after pH 10.5 and an intense precipitate formation was observed at pH 12.5. At the point where a dense precipitate was observed, pH adjustment with NaOH was stopped. In general, the optimum pH range in the production of MgAl LDH is between 9-13. In the present invention, the pH was 12.5.

Then, the formed precipitate was autoclaved and kept at room temperature for 24 hours, and at the end of the period, it was filtered and washed with warm water. This step is a necessary step for obtaining the final product, a ternary MgCaAl layered double hydroxide. Warm water here is water with a temperature of 35° C.

The resulting powder was dried at 40° C. for 12 hours in an incubator.

### 2. Obtaining Composites by Binding Different Polymers to Ternary MgCaAl LDHs

In this step, composite materials are produced by covalently bonding the surfaces of the ternary MgCaAl LDHs obtained as mentioned above with different polymers. Here, the preferred polymers are polyethyleneimine or polyallylamine.

Epoxy Silane Grafting of MgCaAl LDHs: Grafting of epoxy silane on the ternary LDH surface was carried out according to the method performed by Kongparakul et al. (Kongparakul et al., 2017). Firstly, LDH was dispersed in 25 ml of dry toluene at a weight ratio with (3-glycidoxypropyl)trimethoxysilane of LDH/(3-glycidoxypropyl)trimethoxysilane: 0.25 and stirred under reflux condenser for 24 hours. At the end of the period, the samples were washed with toluene, centrifuged and epoxy silane-grafted LDH samples were obtained.

Functionalization of MgCaAl LDH Surface with Polyethyleneimine (PEI): Firstly, PEI (Mn~600 by GPC) was dissolved in 20 mL of dioxane and then epoxy silane grafted LDHs were added thereinto at a weight ratio of PEI/Epoxy grafted sample: 2. The resulting mixture was kept in the inert atmosphere at a temperature of 90° C. and under reflux condenser for 24 hours. At the end of the period, the samples were centrifuged by washing several times with chloroform in order to remove the unreacted PEIs from the structure, thus obtaining PEI-functionalized composites.

Functionalization of ternary MgCaAl LDH with polyallylamine (PAA) was performed by two different methods.

### 1. Method

Methacryl Silane Grafting of MgCaAl LDHs: Grafting of methacryl silane on the ternary LDH surface was carried out according to the method performed by Kongparakul et al. (Kongparakul et al., 2017). Firstly, LDH was dispersed in 25 ml of dry toluene at a weight ratio with methacryl silane of LDH/methacryl silane: 0.25 and stirred under reflux condenser for 24 hours. At the end of the period, the samples were washed with toluene, centrifuged and methacryl silane-grafted LDH samples were obtained.

### Functionalization of Mgcaal Ldh Surface With Polyallylamine (paa): the Ldh Samples Grafted

with methacryl silane were weighed at the weight ratio of LDH grafted with methacryl silane/allylamine: 0.13 and stirred under nitrogen atmosphere, and then 0.1 g/ml aqueous solution of ammonium persulfate was added. The mixture was stirred under a nitrogen atmosphere at 40° C. for 24 hours. At the end of the period, the pH of the mixture was adjusted to 2-3 with HCl. It was centrifuged with 1% HCl solution 2 times and then washed with water, filtered and dried at 100° C.

### 2. Method

Epoxy Silane Grafting of MgCaAl LDHs: Grafting of epoxy silane on the ternary LDH surface was carried out according to the method performed by Kongparakul et al. (Kongparakul et al., 2017). Firstly, LDH was dispersed in 25 ml of dry toluene at a weight ratio with (3-glycidoxypropyl)trimethoxysilane of LDH/(3-glycidoxypropyl)trimethoxysilane: 0.25 and stirred under reflux condenser for 24 hours. At the end of the period, the samples were washed with toluene, centrifuged and epoxy silane-grafted LDH samples were obtained.

Functionalization of MgCaAl LDH Surface with Polyallylamine (PAA): PAA covalent binding on epoxy silane-grafted LDH was carried out according to the method performed by Iarikov et al. (Iarikov, et al., 2014). Firstly, a 10% polyallylamine hydrochloride (PAH) aqueous solution was prepared and the pH of the solution was adjusted with 1 M NaOH to 11. Epoxy-grafted LDH sample was added to this solution and kept at 75° C. for 36 hours. At the end of the period, the sample was filtered and washed twenty times with distilled water to neutral pH. Afterwards, the sample was kept in water in an ultrasonic bath for five minutes to remove PAA that was not covalently bonded to the surface from the structure and was filtered again and left to dry under vacuum.

Since it is important to bind amines to the adsorbent by covalent modification methods in order to obtain amine-modified materials with high stability under steam conditions, in the present invention, PEI and PAA polymers are bonded to the LDH surface by covalent bonding.

In addition to these, PEI and PAA polymers were preferred due to the high number of amines. Thus, it is predicted that the CO₂ capture capacities of samples modified with PEI and PAA polymers will be higher than the capacity of samples previously modified with polymers or aminosilanes in the literature.

What is claimed is:

1. A synthesis method of ternary MgCaAl layered double hydroxide (MgCaAl-LDH), comprising the following steps:
i, calcining eggshells to obtain calcined eggshells;
ii, dissolving the calcined eggshells to obtain a homogeneous solution;
iii, adding magnesium nitrate hexahydrate and aluminum nitrate nonahydrate metal salts to the homogeneous solution and then stirring to obtain a reaction solution;
iv. precipitating the reaction solution with a pH adjustment to form a precipitate;
v. after keeping the precipitate at a room temperature for a predetermined period of time, filtering and washing with water to obtain a powder; and
vi, drying the powder to obtain the MgCaAl-LDH

2. The synthesis method according to claim 1, wherein in the step i, a calcination of the eggshells is carried out at 950° C.

3. The synthesis method according to claim 1, wherein in the step ii, the calcined eggshells are completely dissolved at 70° C. by keeping the calcined eggshells in an ultrasonic bath for 1 hour under an inert nitrogen atmosphere in a 6 M nitric acid solution.

4. The synthesis method according to claim 1, wherein the magnesium nitrate hexahydrate and the aluminum nitrate nonahydrate metal salts are added to the homogeneous solution obtained in the step ii with a molar ratio of Ca⁺²/Al⁺³: 0.15 and a molar ratio of Mg⁺²/Al⁺³: 1.3 and stirred.

5. The synthesis method according to claim 1, wherein in the step iv, a precipitation process is carried out by adding NaOH to the acidie reaction solution.

6. The synthesis method according to claim 1, wherein in the step v, the precipitate is kept at the room temperature for 24 hours, then filtered and washed with the water.

7. The synthesis method according to claim 1, wherein in the step vi, the powder is dried at 40° C. for 12 hours in an incubator to obtain the MgCaAl-LDH.

8. A MgCaAl-LDH obtained by the synthesis method according to claim 1.

9. A composite containing the MgCaAl-LDH according to claim 8.

10. The composite according to claim 9, wherein the composite is modified with polyethyleneimine or polyallylamine.

11. A CO₂ adsorbent made of the composite according to claim 9.

12. A method for preparing a CO₂ adsorbent, comprising using the composite according to claim 9.

13. The MgCaAl-LDH according to claim 8, wherein in the step i of the synthesis method, a calcination of the eggshells is carried out at 950° C.

14. The MgCaAl-LDH according to claim 8, wherein in the step ii of the synthesis method, the calcined eggshells are completely dissolved at 70° C. by keeping the calcined eggshells in an ultrasonic bath for 1 hour under an inert nitrogen atmosphere in a 6 M nitric acid solution.

15. The MgCaAl-LDH according to claim 8, wherein in the synthesis method, the magnesium nitrate hexahydrate and the aluminum nitrate nonahydrate metal salts are added to the homogeneous solution obtained in the step ii with a molar ratio of Ca⁺²/Al⁺³: 0.15 and a molar ratio of Mg⁺²/Al⁺³: 1.3 and stirred.

16. The MgCaAl-LDH according to claim 8, wherein in the step iv of the synthesis method, a precipitation process is carried out by adding NaOH to the reaction solution.

17. The MgCaAl-LDH according to claim 8, wherein in the step v of the synthesis method, the precipitate is kept at the room temperature for 24 hours, then filtered and washed with the water.

18. The MgCaAl-LDH according to claim 8, wherein in the step vi of the synthesis method, the powder is dried at 40° C. for 12 hours in an incubator to obtain the MgCaAl-LDH.

19. The CO₂ adsorbent according to claim 11, wherein the composite is modified with polyethyleneimine or polyallylamine.

20. The method according to claim 12, wherein the composite is modified with polyethyleneimine or polyallylamine.
